(19) United States
(12) Patent Application Publication
(10) Pub. No.: US 2016/0027028 A1
(43) Pub. Date: Jan. 28, 2016

(54) ON-LINE BEHAVIOR RESEARCH METHOD USING CLIENT/CUSTOMER SURVEY/RESPONDENT GROUPS

(71) Applicant: LUTH RESEARCH, San Diego, CA (US)

(72) Inventors: Roseanne LUTH, Rancho Santa Fe, CA (US); Baixue WU, San Diego, CA (US)

(21) Appl. No.: 14/813,773

(22) Filed: Jul. 30, 2015

Related U.S. Application Data
(63) Continuation of application No. 13/726,947, filed on Dec. 26, 2012, now abandoned.
(60) Provisional application No. 61/580,285, filed on Dec. 26, 2011.

(51) Int. Cl. G06Q 30/02

(52) U.S. Cl. CPC G06Q 30/0203; G06Q 30/0201

(57) ABSTRACT

The present invention is directed to a computer implemented web-based system for on-line behavior research using client/customer survey/research respondent groups known as tribes comprising a) a definition module for the purpose of defining client/customer survey/research respondent groups known as tribes; b) a recruitment module for the purpose of recruiting a defined client/customer survey/research respondent group known as a tribe; c) a fielding module for the purpose of fielding a defined and recruited client/customer survey/research respondent group known as a tribe to generate a tribe data set; and d) an analysis and reporting module for the purpose of analyzing and reporting on the tribe data set to generate optimal tribe recommendations, whereby said system provides the capability to custom recruit research respondents for online behavior monitoring based on client-provided criteria, and provides an integrated approach to combining behavioral data and survey data to derive a broader and more in-depth understanding of human decisions.

### CROSS-REFERENCE TO RELATED APPLICATIONS

This application is a continuation of U.S. application Ser. No. 13/726,947, filed Dec. 26, 2012, which is based on, and claims priority to U.S. Provisional Application No. 61/580,285, filed Dec. 26, 2011, the entire contents of each of which being fully incorporated herein by reference.

### FIELD OF THE INVENTION

The present invention is directed to a system and method for researching on-line behavior, and more particularly to a web-based system and method for researching on-line behavior utilizing client/customer survey/research respondent groups to derive an optimal understanding of on-line consumer behavior, wherein the system and method provides companies with an integrated approach combining behavioral data and survey data to derive a broader and more in-depth understanding of human decisions.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND OF THE INVENTION

Digital marketing, advertisement and electronic commerce or “eCommerce” is on the rise worldwide, and as a result online behaviors and advertisement influences relating to products and services interest and purchases occur with greater frequency than ever by millions of users and purchasers worldwide.

There is a growing need for solid and accurate measurement of user's on-line behavior and the ability to enable accurate and reliable recommendations to those on-line users and purchasers. Most have solved this problem by using more and more complicated software running behind the displays of websites and on-line retail outlets.

Therefore, it would be highly desirable to have a system and method for researching on-line behavior utilizing client/customer survey/research respondent groups to provide the ability to custom recruit research respondents for online behavior monitoring based on client-provided criteria, affording companies a much higher degree of precision in researching the target audience.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

The principle advantage of the system and method for researching on-line behavior utilizing client/customer survey/research respondent groups is to provide a system and method which enables one to derive an optimal understanding of on-line behavior.

Another advantage of the system and method for researching on-line behavior utilizing client/customer survey/research respondent groups is to provide the ability to custom recruit research respondents for online behavior monitoring based on client-provided criteria, affording companies a much higher degree of precision in researching the target audience.

Another advantage of the system and method for researching on-line behavior utilizing client/customer survey/research respondent groups is to provide a different, more engaging way to involve respondents to provide data about themselves in an authentic manner.

Another object of the system and method for researching on-line behavior utilizing client/customer survey/research respondent groups is to provide a greater flexibility to implement online behavioral tracking software among research respondents from a wide variety of sources including client customer base or other research panels, adding a powerful dimension of insights about consumers and the marketplace otherwise unattainable from traditional market research.

Another object of the system and method for researching on-line behavior utilizing client/customer survey/research respondent groups is to provide a superior recruitment process and data validation process that deliver on efficiency in time and cost.

Another object of the system and method for researching on-line behavior utilizing client/customer survey/research respondent groups is to provide an easy engagement protocol to provide continuous capturing of consumer activities on the Internet based on a client-determined time frame, which can be 30 days, 60 days or longer.

And yet another object of the system and method for researching on-line behavior utilizing client/customer survey/research respondent groups is to enable the ability to integrate both survey, online behavioral data and other forms of data to derive most holistic understanding of consumers.

And yet a further object of the system and method for researching on-line behavior utilizing client/customer survey/research respondent groups is to provide proven metrics and analytical procedures that yield tangible understanding of marketing implications such as how many visits to a specific type of website on average during a 6-month time frame would achieve a 200% lift in purchase likelihood.

Throughout the present patent application the disclosed invention directed to a system and method for researching on-line behavior utilizing client/customer survey/research respondent groups, will be known as the “ZQ Digital Tribe” or just a “ZQ Tribe” process/method and/or system. ZQ Digital Tribe is research methodology leveraged to help clients better understand consumer's online behavior. The research data collected via this methodology is used to support clients with their advertising, marketing and branding strategies and campaigns as well as other business operations. ZQ Digital Tribe is an opt-in digital community comprised of members who allow for their online activity to be tracked and also participate in online research surveys. The digital community consists of a group of users that have downloaded and installed the SavvyConnect application and any additional media usage tracking technologies.

The process for implementing a ZQ tribe begins with the definition of the objectives, scope and type of the tribe and deliverables required. The types of Tribe include but are not limited to Impact Monitoring, Digital Life, Cross Media, Multi-Sense and Behavioral Pattern. Each type of Tribe has its own methodology and implementation.

All data collected by the SavvyConnect application and other systems and processes during a Digital Tribe is integrated together for analysis. The ZQ Digital Tribe members may differ for each Tribe and are customized based on the respondent criteria identified by the client. The Tribes are active for a designated period of time. The respondent criteria and the timeframe of the Digital Tribe are determined based on the overall business objectives and research needs identified by the client.

The digital data is analyzed to answer questions about what individuals are actually doing online and additional data is integrated to answer the questions about why consumers participate in the online activity. The additional data integrations may include research surveys, focus groups, demographic data, profiling data, other forms of behavioral tracking data (such as mobile device tracking, gaming device tracking, TV streaming device tracking), and third party data.

The SavvyConnect application is available from the Applicant Luth Research, LLC and is the subject of a previously filed US Utility patent application, U.S. Ser. No. 12/818,603, titled SYSTEM AND METHOD FOR COLLECTING CONSUMER DATA, filed on Jun. 18, 2010, based upon the previously filed U.S. Provisional Patent Application Ser. No. 61/269,218, filed on Jun. 22, 2009, both of the above listed US patent applications are incorporated by reference in their entirety herein.

The SavvyConnect application comprises a system having a plurality of client devices connected to the internet. The client devices detect and collect information regarding a user's browsing activity and transmit this information to server via the internet. The client device is any device capable of communication over the internet via a browser including, but not limited to, general purpose computers, internet ready telephones and other wireless communication devices, internet enabled TVs and auxiliary devices, etc. The server is a computer located at a central site for receiving and processing the information gathered by client devices. The client device includes data input elements such as a keyboard or pointing devices. the client further includes appropriate communications hardware and volatile and non-volatile memory elements in or on which are stored an operating system and application software which allow a user to send and receive data. such software includes application software commonly referred to as a browser such as Internet Explorer, Firefox, Safari, Chrome and the like.

It must be clearly understood at this time although the preferred embodiment consists of the system and method for researching on-line behavior utilizing client/customer survey/research respondent groups, that many conventional mechanical devices exist, that would allow for implementation and deployment of the present system and method, including computers, cell phones, smart phones and other mobile computing devices, wireless devices, kiosks, televisions, smart televisions, telephone systems and other systems and devices which enable connection to a worldwide computer network, or combinations thereof, that will achieve a similar operation and they will also be fully covered within the scope of this patent.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1A depicts a flow chart of the basic essential ZQ Tribe process including the basic modules/steps of definition, recruitment, fielding and analysis and reporting;

FIG. 1B depicts a schematic diagram scenario and flow chart of one possible distribution of components across multiple computers on a network, in which the ZQ Tribe process will take place;

FIG. 2 depicts a more detailed flow chart of the ZQ Tribe process illustrating the basic modules/steps of definition, recruitment, fielding and analysis and reporting with greater detail and showing numerous sub-modules/steps within each category;

FIGS. 3A, 3B and 3C depicts a more detailed flow chart of the ZQ Tribe process illustrating the basic modules/steps of tribe definition in greater detail, leading up to defining a tribe;

FIGS. 4A and 4B depicts a more detailed flow chart of the ZQ Tribe process illustrating the basic modules/steps of tribe recruitment in greater detail, leading up to qualifying a tribe;

FIG. 5A depicts the initial steps of a more detailed flow chart of the ZQ Tribe process illustrating the basic modules/steps of tribe fielding in greater detail, resulting in a ZQ Tribe data set;

FIG. 5B depicts the remaining steps of a more detailed flow chart of the ZQ Tribe process illustrating the basic modules/steps of tribe fielding in greater detail, resulting in a ZQ Tribe data set;

FIG. 6A depicts the initial steps of a more detailed flow chart of the ZQ Tribe process illustrating the basic modules/steps of tribe analysis and reporting in greater detail, resulting in tribe recommendations;

FIG. 6B depicts the remaining steps of a more detailed flow chart of the ZQ Tribe process illustrating the basic modules/steps of tribe analysis and reporting in greater detail, resulting in tribe recommendations;

FIG. 7 depicts a weekly pattern report in tabular/graphical form showing the relationships between core gamers, enthusiasts and less invested individuals;

FIG. 8 depicts a search term category report in tabular/graphical form showing the relationships between core gamers, enthusiasts and less invested individuals impacted by gaming related search terms;

FIG. 9 depicts a web site correlation report in tabular/graphical form showing the affinities of core gamers, enthusiasts and less invested individuals to particular web sites;

FIG. 10 depicts a best path report in tabular/graphical form showing the categories of web sites visited by users before they visited the target gaming websites of interest to the client; and

FIG. 11 depicts a tabular/graphical analysis of the impact on brand affinity with respect to service providers, search engines and social media sites.

### DETAILED DESCRIPTION OF THE PREFERRED EMBODIMENTS

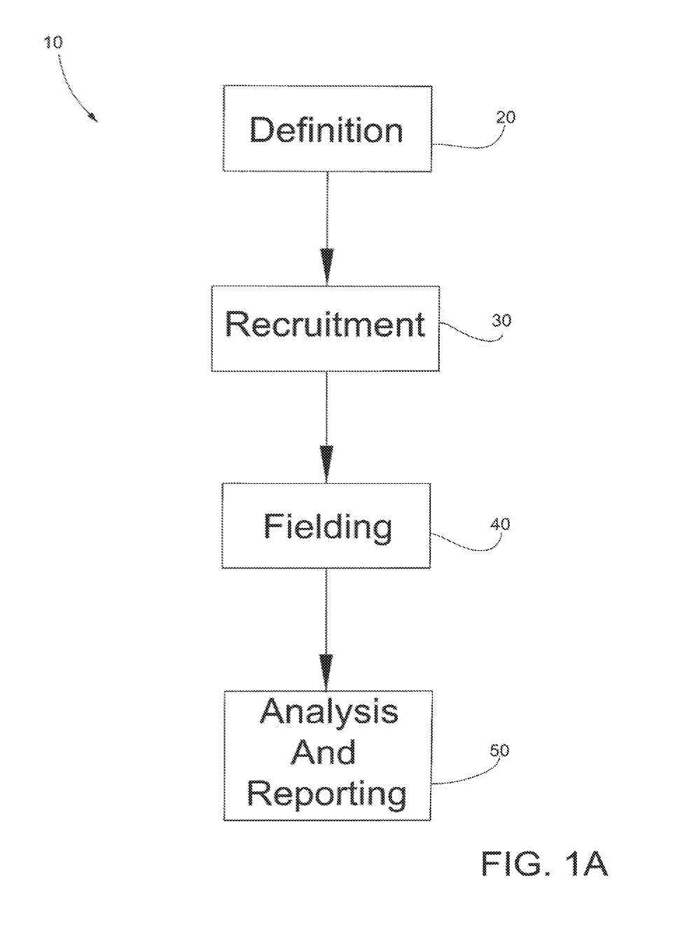

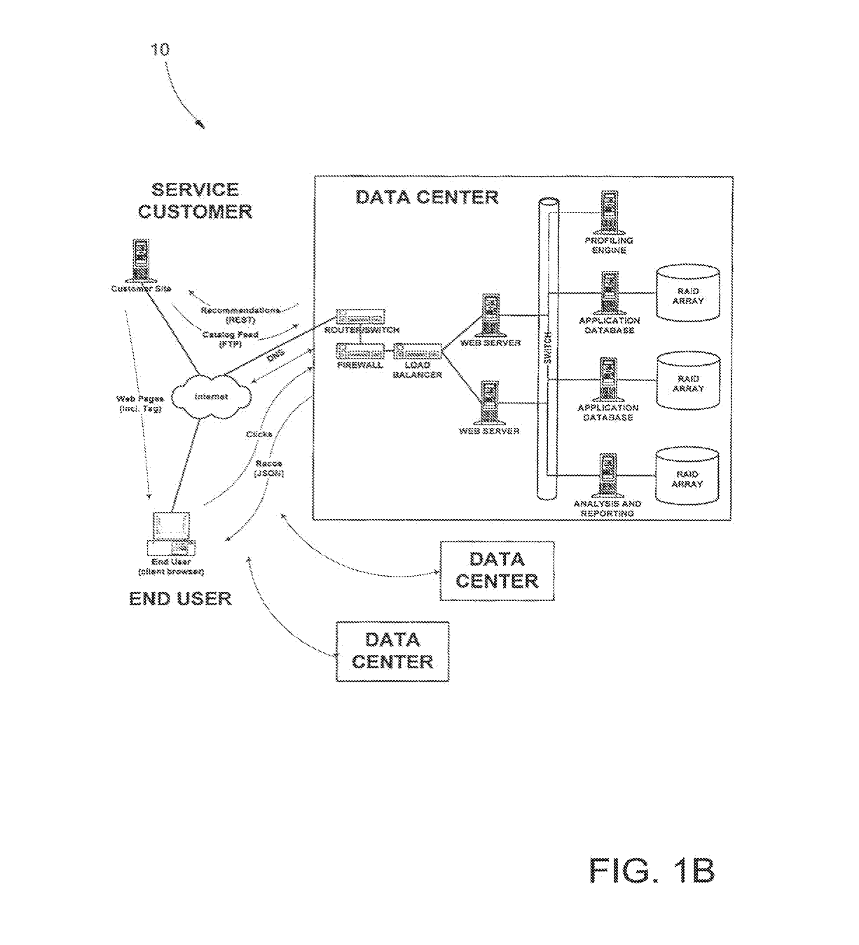

For a fuller understanding of the nature and objects of the invention, reference should be had to the following detailed description taken in conjunction with the accompanying drawings wherein similar parts of the invention are identified by like reference numerals. There is seen in FIG. 1A a basic overview flow chart of the ZQ Tribe system process 10, which includes a definition module 20, a recruitment module 30, a fielding module 40 and an analysis and reporting module 50. This ZQ Tribe system does not always require the analysis module and the reporting module, allowing for a possible scenario where the client will obtain the data directly and handle the analysis on the client side.

FIG. 1B shows an embodiment of the delivery of the computer implemented web-based ZQ Tribe system over the Internet. The end use application (here shown as a Service Customer) is a website that is external to the system and that communicates with the system via web services from the customer website or directly from the customer website's end user's client browser. As shown, the system may be distributed across multiple computers on a network. This consists of one or more web servers (or web farm), which collect data and process content recommendation requests. The web servers pass data to one or more application databases via a message queuing system that allows the web servers to continue processing while the much slower database servers feed the data into permanent storage, such as non-volatile RAM, direct-attached RAID array, network attached storage (NAS), or storage area network (SAN). The application databases and web servers would store and make available the SavvyConnect communication application downloads, browser toolbars, survey data and the ZQ database, as they administer the ZQ Tribe system and process described herein.

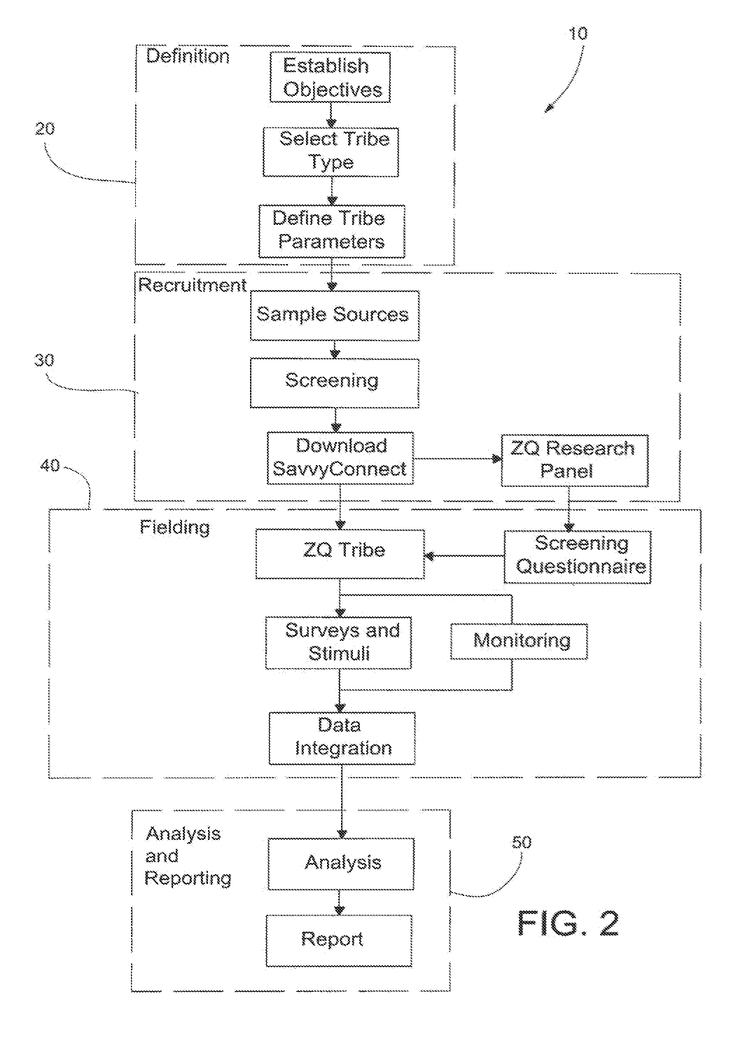

FIG. 2 depicts a more detailed flow chart of the ZQ Tribe system process 10 illustrating the basic steps of definition, recruitment, fielding and analysis and reporting with greater detail and showing numerous sub-steps within each category. The definition module 20 consists of the sub-modules/steps of establishing objectives, selecting tribe types and defining tribe parameters. The recruitment module 30 comprises the sub-modules/steps of sampling sources, screening, and downloading SavvyConnect, leading to a ZQ Research Panel or a ZQ Tribe. The fielding module 40 allows for a screening questionnaire leading to a ZQ Tribe. The sub-modules/steps of performing surveys and stimuli, monitoring and data integration follow the ZQ Tribe recruitment in the fielding module 40. Within the analysis and reporting module 50, there are sub-modules/steps for the analysis of the data and for report generation.

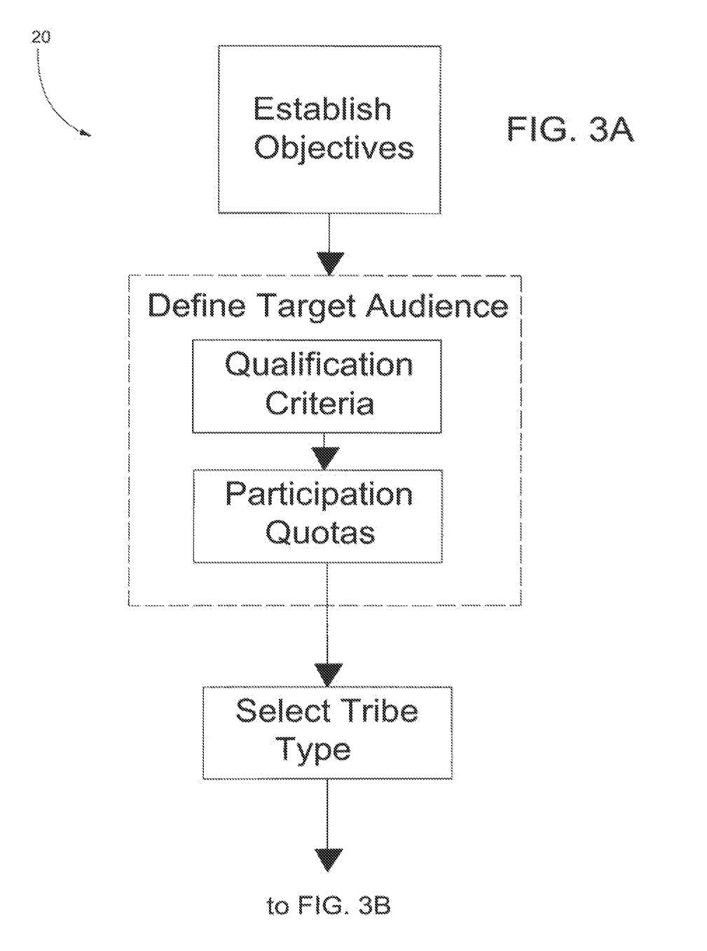

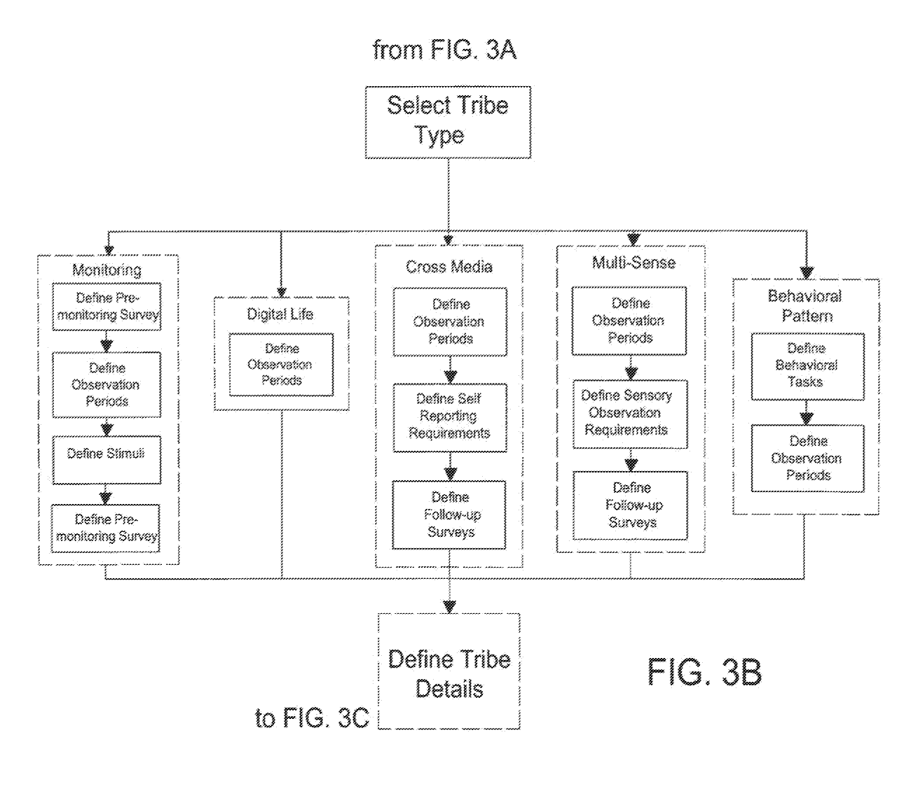

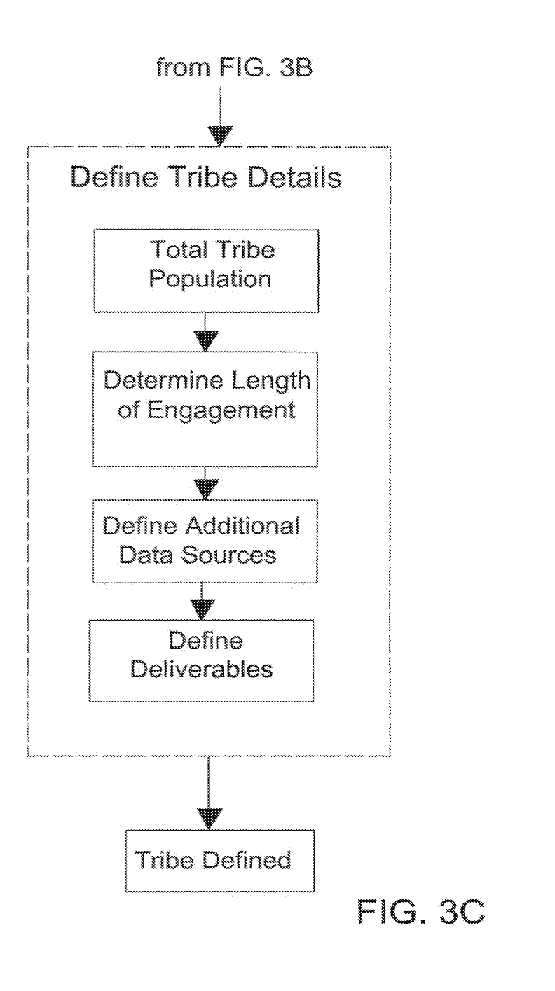

FIGS. 3A, 3B and 3C depicts a more detailed flow chart of the ZQ Tribe process 10 definition module 20, illustrating the basic step of tribe definition in greater detail, leading up to defining a tribe. After establishing objectives, a target audience is defined using pre-determined qualification criteria and participation quotas. A Tribe type is selected and run through sub-modules, including monitoring, digital life, cross media, multi-sense, and behavioral pattern. Finally, within this definition module 20, tribe details are defined by employing total tribe population data, determining the length of engagement, defining additional data sources and defining deliverables. The result of definition module 20 is that a tribe is defined through this detailed calculation process.

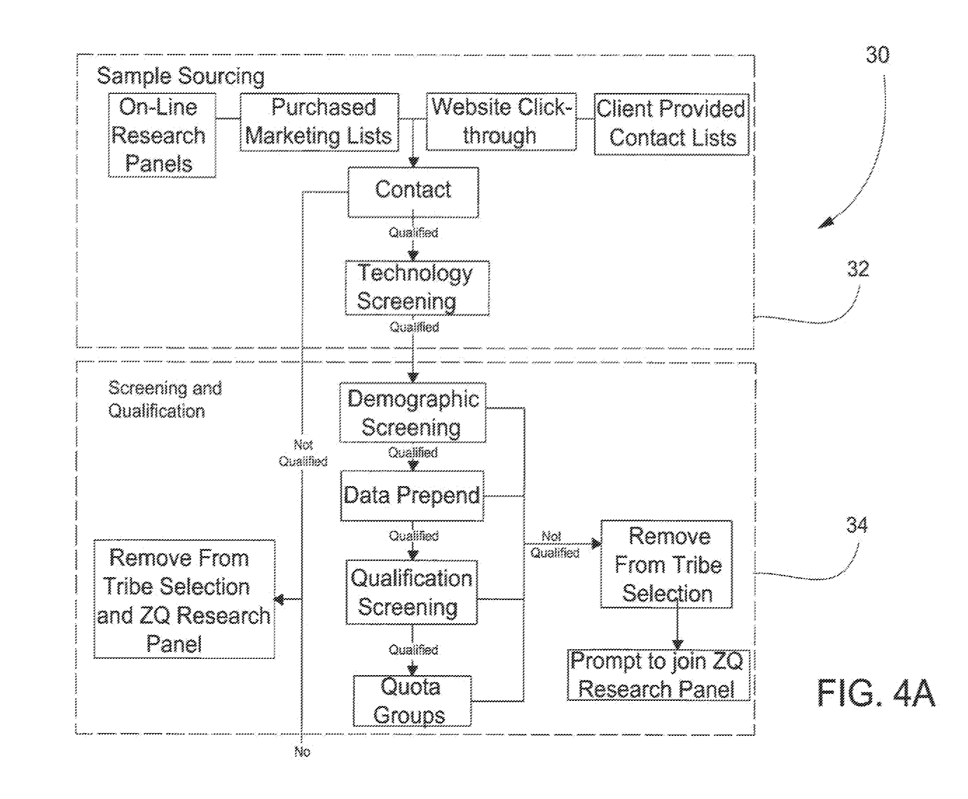

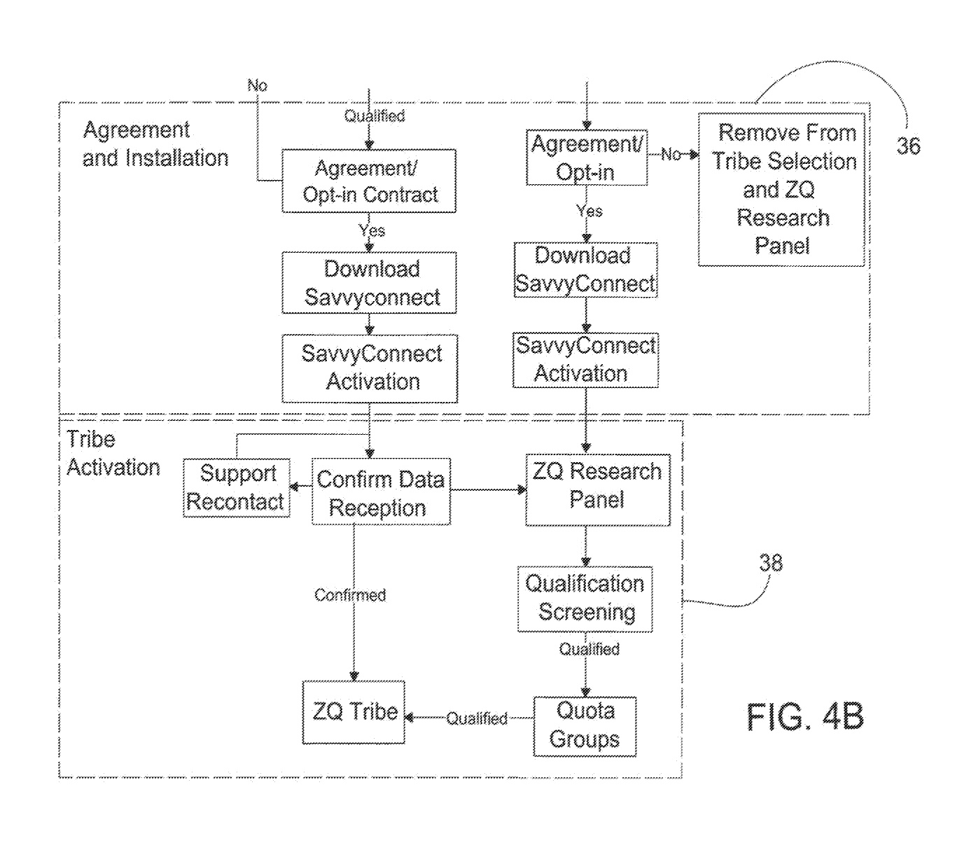

FIGS. 4A and 4B depict a more detailed flow chart of the ZQ Tribe process 10 illustrating the basic steps of the tribe recruitment module 30 in greater detail, leading up to qualifying a tribe. The recruitment module 30 consists of sub-modules sample sourcing 32, screening and qualification 34, agreement and installation 36, and tribe activation 38, all leading up to qualified quota groups and ultimately a qualified ZQ Tribe.

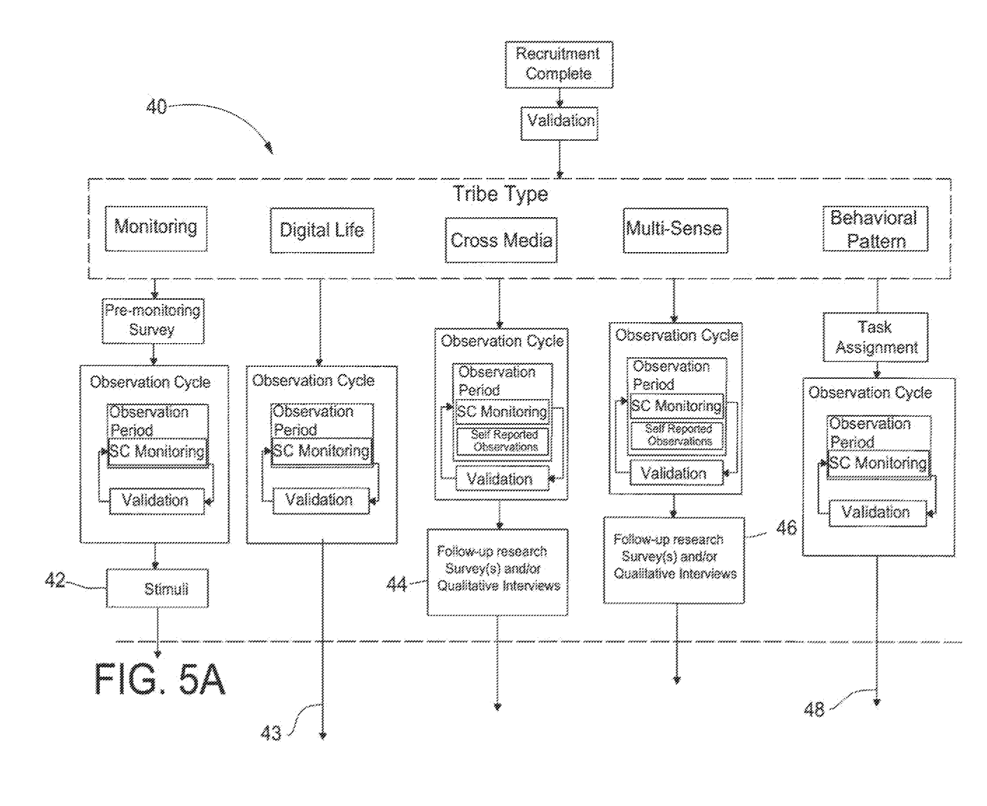

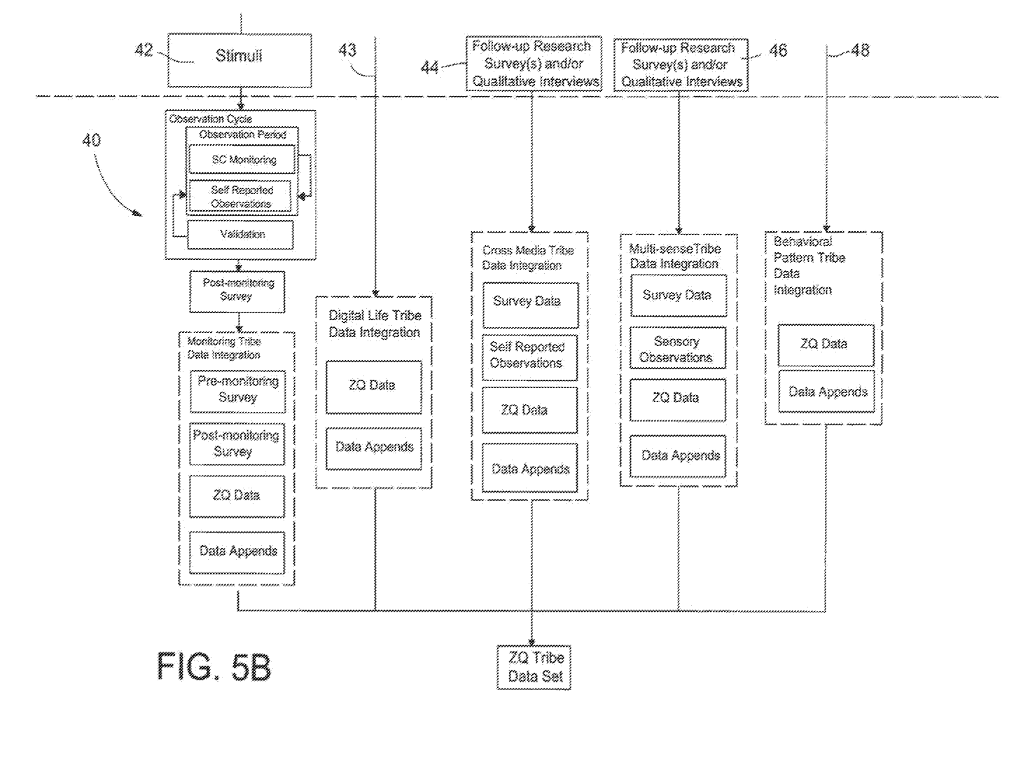

FIGS. 5A and 5B depict a more detailed flow chart of the ZQ Tribe process 10 illustrating the basic steps of the tribe fielding module 40 in greater detail, resulting in a ZQ tribe data set. Following the completion of recruitment, data collection occurs, in five pathways. Pathway (1) monitoring involving a pre-monitoring survey, an observation cycle, stimuli, another observation cycle, a post-monitoring survey, optional qualitative in-depth interviews and monitoring tribe data integration. Pathway (2) involves digital life analysis, an observation cycle, possible qualitative in-depth interviews and digital life tribe data integration. Pathway (3) involves cross-media analysis, an observation cycle, one or more follow-up research surveys, possible qualitative in-depth interviews and cross-media tribe data integration. Pathway (4) employs multi-sense analysis, an observation cycle, one or more follow-up research surveys, possible qualitative in-depth interviews and multi-sense tribe data integration. Pathway (5) uses behavior pattern analysis, followed by task assignment, an observation cycle, one or more follow-up research surveys, possible qualitative in-depth interviews and behavioral pattern tribe data integration. The qualitative research component described is optional in the fielding module, specifically the data integration step, and the analysis/reporting module specifically in the analysis step, and may be omitted.

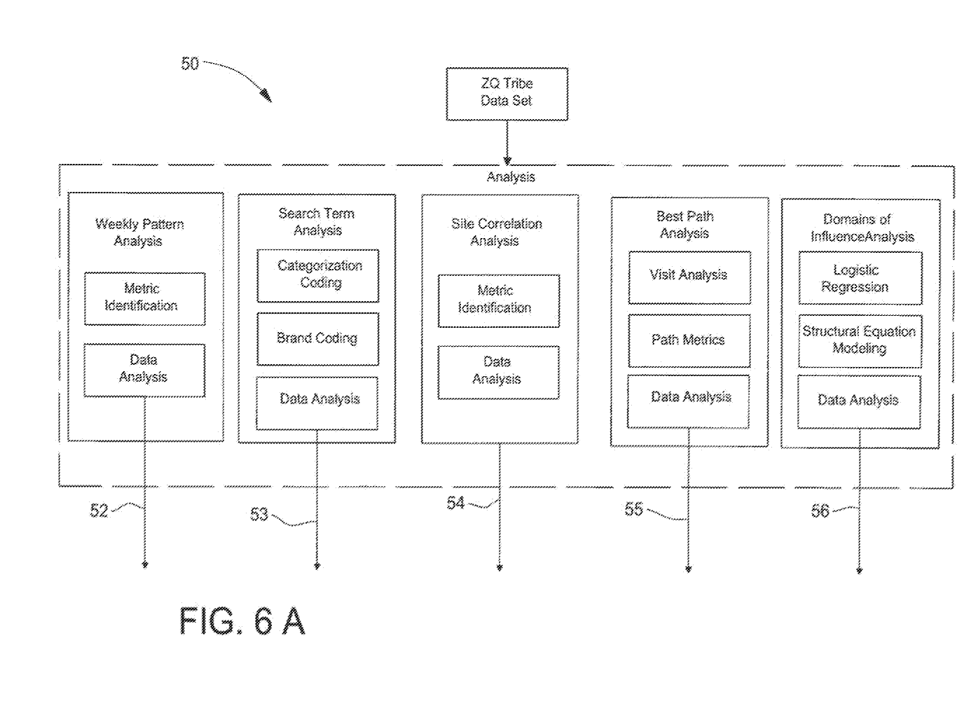

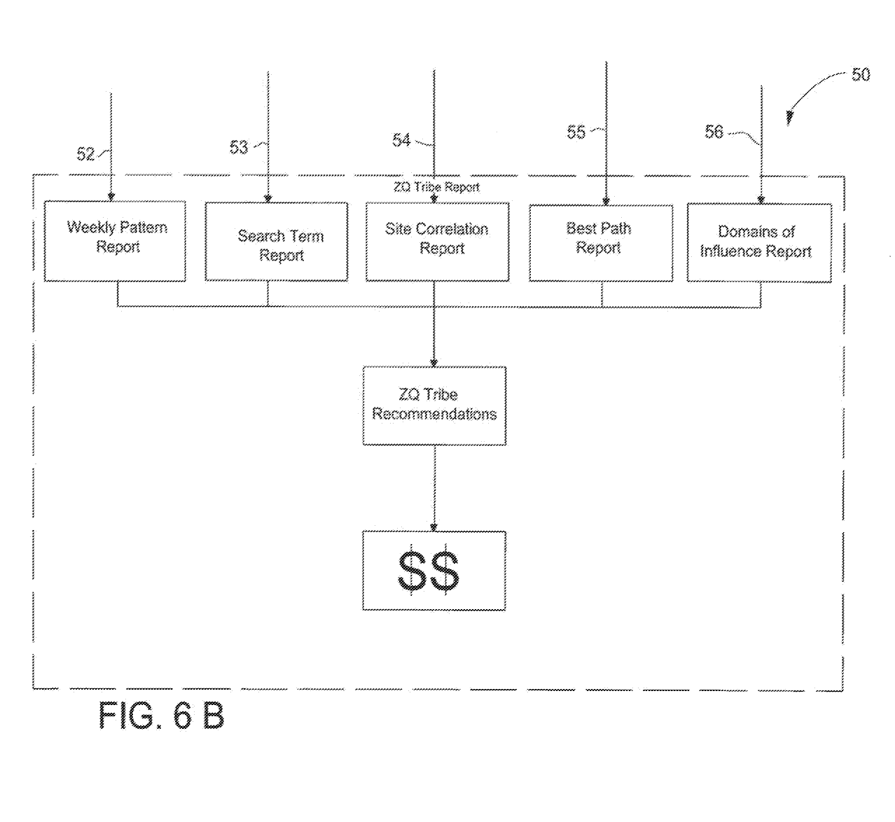

FIGS. 6A and 6B depict a more detailed flow chart of the ZQ Tribe process 10 illustrating the basic steps of the tribe analysis and reporting module 50 in greater detail, resulting in tribe recommendations. ZQ Tribe data sets are run through a collection of analytical procedures including weekly pattern or day part pattern analysis, search term analysis, site correlation analysis, best path analysis and domains of influence analysis. These analysis procedures can be selected by the client to be implemented individually or as a group to best address research objectives outlined at the onset of the tribe. Performance of these analyses, results in the generation of ZQ Tribe reports, including weekly pattern analysis reports, search term analysis reports, site correlation analysis reports, best path analysis reports and domains of influence analysis reports, all of which lead to ZQ Tribe recommendations which are generated to guide the client's decisions and actions to achieve more effective marketing practices and enhance business outcome.

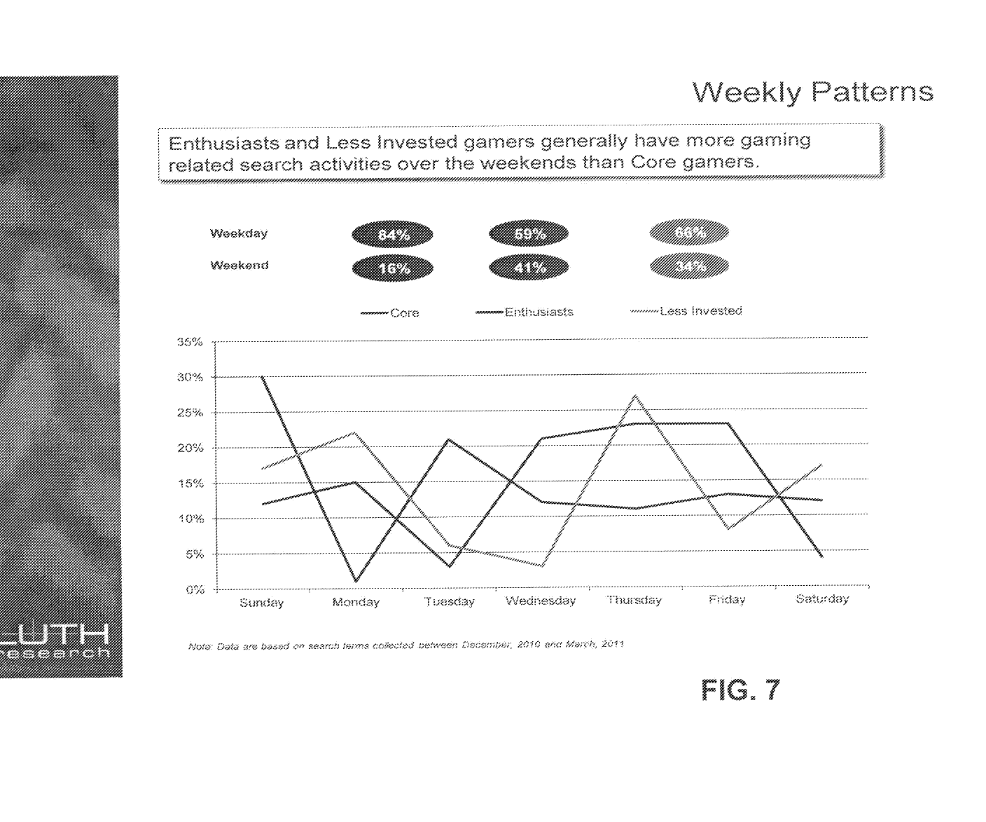

FIG. 7 depicts a weekly pattern report in graphic form showing the relationships between core gamers, enthusiasts and less invested individuals. In greater detail this weekly pattern analysis report process can be described as follows:

Weekly Pattern/Day Part Pattern Analysis

Brief Description:

The data for the identified relevant metrics (e.g., search terms, visits, etc.) are analyzed tracing how the activities fluctuate across weekdays and weekends or across the various day parts in a typical day. The peaks and lows of the activities indicate opportunities for companies to increase or decrease marketing efforts based on time patterns.

Step 1—Data Preparation:
i. Extract data from ZQ Data warehouse (Greenplum01) and import the data into SPSS
   1. Extract visits data using the SQL script below from the table dw_zq.dw_rq0003_{—}01_websitesvisited_mv in Greenplum01 with in time frame 01-01-2011 to 06-08-2011 for Consumer Electronic survey respondents. Export the data to excel and import it to SPSS.
      a. R:\custom\2010\ACTIVE PROJECTS\LUTH—L9993 ZQ Consumer Electronics Survey\Specs\SQL\Mobile_WebVisitCounts_Week day_{—}8_{—}10
ii. Merge ZQ data with survey data
   1. R:\custom\2010\ACTIVE PROJECTS\LUTH—L9993 ZQ Consumer Electronics Survey\Data\Combined_Data_CellPhone_{—}8_{—}10.sav
   2. R:\custom\2010\ACTIVE PROJECTS\LUTH—L9993 ZQ Consumer Electronics Survey\Data\Combined_Data_CellPhone_{—}0727.sav
iii. Get visits data for graph
   1. Use the SPSS Script below to extract weekly (or hourly) visits data for Service Provider Sites and Shopping Sites among those who made a cell phone purchase in the last 4 months.
      a. R:\custom\2010\ACTIVE PROJECTS\LUTH—L9993 ZQ Consumer Electronics Survey\Tabs\ WeeklyVisits_Cell_shopping_service. SPS
   2. Use the Script below to extract weekly (or hourly) visits data for User Generated Sites among those who gave ratings of 7-10.
      a. R:\custom\2010\ACTIVE PROJECTS\LUTH—L9993 ZQ Consumer Electronics Survey\Tabs\ WeeklyVisits_Cell_UserGenerated.SPS

b. Step 2—Data Analysis:
i. Calculate the percentage of the visits for each day in one week (or for each hour in a day) in the workbooks below.
   1. R:\custom\2010\ACTIVE PROJECTS\LUTH—L9993 ZQ Consumer Electronics Survey\Tabs\WeeklyPatternAnalysis_ShoppingVsServiceP rovider.xls
   2. R:\custom\2010\ACTIVE PROJECTS\LUTH—L9993 ZQ Consumer Electronics Survey\Tabs\WeeklyPatternAnalysis_UserGeneratedSites.xlsx

c. Step 3—Output:
i. The graphs are shown in the worksheet ‘graph’ in the workbooks below.
   1. R:\custom\2010\ACTIVE PROJECTS\LUTH—L9993 ZQ Consumer Electronics Survey\Tabs\WeeklyPatternAnalysis_ShoppingVsServiceP rovider.xls
   2. R:\custom\2010\ACTIVE PROJECTS\LUTH—L9993 ZQ Consumer Electronics Survey\Tabs\WeeklyPatternAnalysis_UserGeneratedSites.xlsx

d. Data Sources in the ZQ Data:
i. dw_zq.dw_rq0003_{—}01_websitesvisited_mv

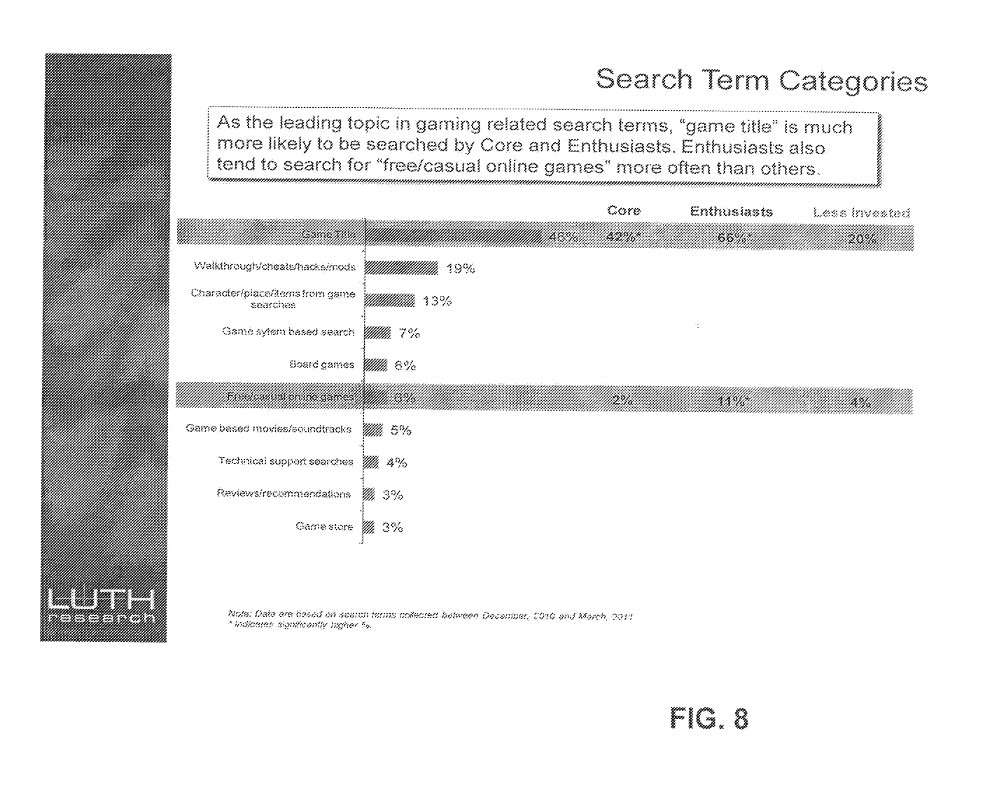

FIG. 8 depicts a search term category report in graphic form showing the relationships between core garners, enthusiasts and less invested individuals impacted by gaming related search terms. In greater detail this search term analysis category report process can be described as follows:

Search Term Analysis

a. Brief Description:
Search is a common consumer activity online. Search term analysis has two dimensions. First, search terms are coded into categories or themes that are relevant to a topic of interest (e.g., searches for digital camera). Second, search terms are coded in terms of whether each search term contains a brand name, which allows researchers to analyze the significance of branded searches as opposed to unbranded searches. Insights from this analysis inform decisions on search engine optimization strategies, and quantify the impact of search within a specific product category.

b. Step 1—Data Preparation:
ii. Run SQL query to get data on search terms.
   1. R:\custom\2010\ACTIVE PROJECTS\LUTH—L9993 ZQ Consumer Electronics Survey\Specs\SQL\Search Term Query.
   2. Note to update the search term list using coding performed by the project manager.
iii. Combine ZQ data with survey data using member_id (which is QID in survey) as the key word, and generate a SPSS file. Code each search term into three categories: Search Term_Type, Search Term_Objective, Search Term Branded Search according to coding done by the project manager.
   1. R:\custom\2010\ACTIVE PROJECTS\LUTH—L9993 ZQ Consumer Electronics Survey\Data\Search Term Mobile.sav;
   2. R:\custom\2010\ACTIVE PROJECTS\LUTH—L9993 ZQ Consumer Electronics Survey\Data\Search Term Camera.sav.
iv. Aggregate search terms into member_id/search term category level. For each product, there are three such files with one for each category. These files are the ones we use to run models.
   1. R:\custom\2010\ACTIVE PROJECTS\LUTH—L9993 ZQ Consumer Electronics Survey\Data\aggr type mobile.sav;
   2. R:\custom\2010\ACTIVE PROJECTS\LUTH—L9993 ZQ Consumer Electronics Survey\Data\aggr_objective_mobile.sav;
   3. R:\custom\2010\ACTIVE PROJECTS\LUTH—L9993 ZQ Consumer Electronics Survey\Data\aggr_branded_mobile.sav;
   4. R:\custom\2010\ACTIVE PROJECTS\LUTH—L9993 ZQ Consumer Electronics Survey\Data\aggr type camera.sav;
   5. R:\custom\2010\ACTIVE PROJECTS\LUTH—L9993 ZQ Consumer Electronics Survey\Data\aggr_objective_camera.sav;
   6. R:\custom\2010\ACTIVE PROJECTS\LUTH—L9993 ZQ Consumer Electronics Survey\Data\aggr_branded_camera.sav

c. Step 2—Data Analysis:
v. Run logistic regression and GLM to identify the impacts of search terms on the purchase timeframe and brand affinity for cell phone and digital camera respectively.
   1. R:\custom\2010\ACTIVE PROJECTS\LUTH—L9993 ZQ Consumer Electronics Survey\Tabs\Search Term_Mobile.spv;
   2. R:\custom\2010\ACTIVE PROJECTS\LUTH—L9993 ZQ Consumer Electronics Survey\Tabs\Search Term_Camera.spv.

d. Step 3—Output:
vi. R:\custom\2010\ACTIVE PROJECTS\LUTH—L9993 ZQ Consumer Electronics Survey\Tabs\Search_Term_Mobile.xlsx;
vii. R:\custom\2010\ACTIVE PROJECTS\LUTH—L9993 ZQ Consumer Electronics Survey\Tabs\Search_Term_Camera.xlsx;

e. Data Sources in the ZQ Data:

Greenplum database and the table is: st_zq_operational.st_searches

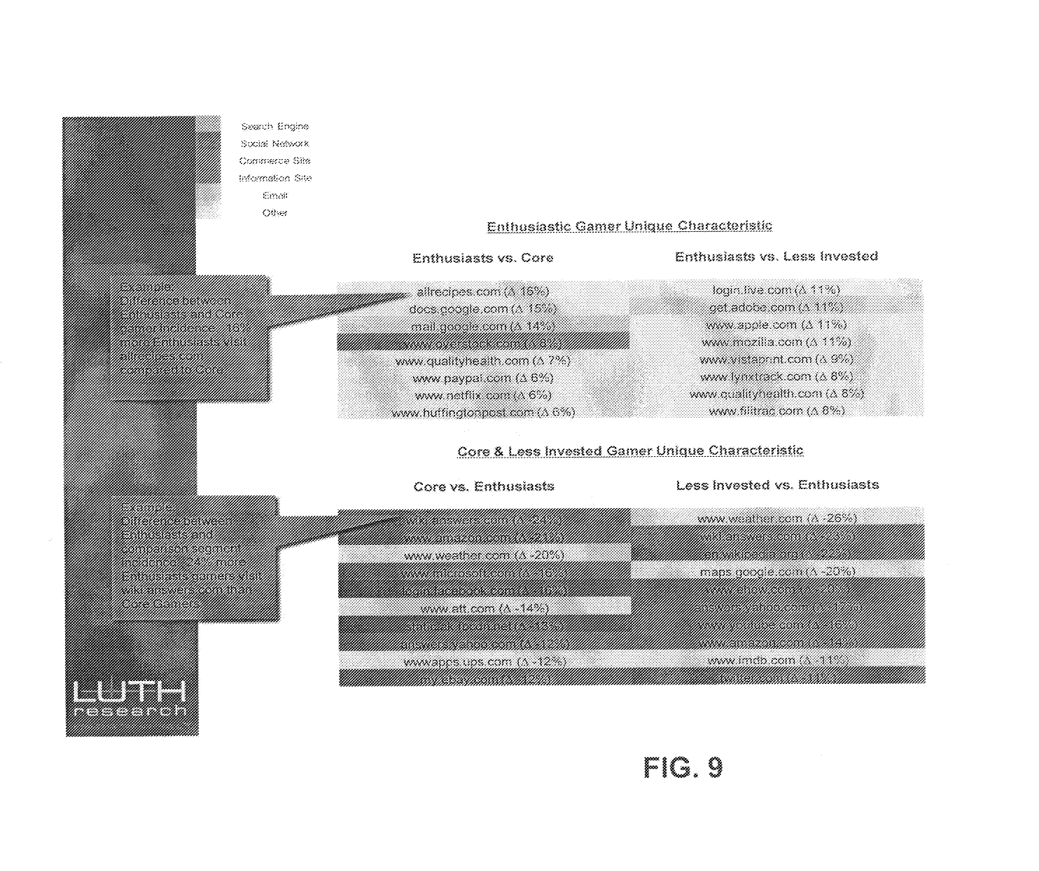

FIG. 9 depicts a web site correlation report in tabular/graphic form showing the affinities of core garners, enthusiasts and less invested individuals to particular web sites. In greater detail this web site correlation category analysis report process can be described as follows:

Site Correlation Analysis

a. Brief Description:
Visitors to target websites of interest identified by the client are examined to determine what other websites they visit are of high probability and high relevance to the research topics. A group of highly visited websites by these visitors are compiled and categorized based on their degree of correlation to the target websites of interest. Clients can leverage the insights to drive cross-site traffic and identify optimal destinations to attract target audience.

b. Step 1—Data Preparation:

Extract list of unique websites visited by tribe participants from ZQ database. Using an external resource, classify each unique website in the appropriate category. Upload website categorization classification to ZQ database.

a. Step 2—Data Analysis:

Cross each client identified target website of interest by the website categorization variable.

c. Step 3—Output:

Rank order list of website categories by each target website of interest.

b. Data Sources in the ZQ Data:

Tables st_zq_operational.st_site_categories and st_zq_operational.st_website_category_mappings in the Greenplum database

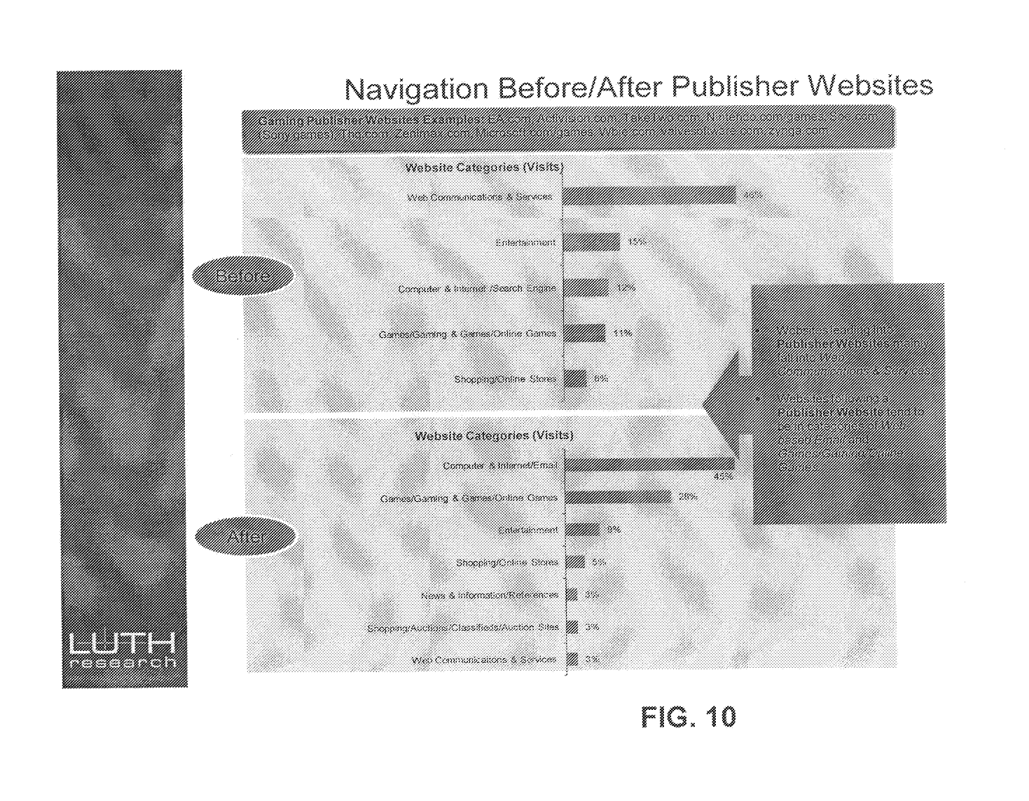

FIG. 10 depicts a best path report in graphic form showing the web sites between core garners, enthusiasts and less invested individuals. In greater detail this search term analysis category report process can be described as follows:

Best Path Analysis

a. Brief Description:
For every website of interest or domain of influence, there is a digital path leading to it and another one it leads to. This analysis answers questions such as “Does most of the traffic to the website come from search engine?”, “How many other websites on average do consumers visit prior to coming to my website?”, “Where do my customers go after they leave my website?” The analysis not only provides competitive intelligence on consumer shopping and content consumption behaviors, but also exposes the underlying digital path which can be shaped by relevant marketing tactics.

b. Step 1—Data Preparation:
1. Create a data file including all the before and after web visits for each member at each web visit.
   Run SQL query
   R:\custom\2010\ACTIVE PROJECTS\Hall & Partners—L4456 Toyota Web Tracking\Specs\SQL\Before_After_Toyota_All.
   Following step-by-step instruction and create a complete before and after visit data file in 5 steps.
      i. Clean the raw data file of dw_zq.dw_website_visits_clean;
      ii. Create target member_id list;
      iii. Create before and after navigation base file;
      iv. Create target website id list;
      v. Create the complete before and after visit data file.
         In Toyota Tribe case, the file is dw_zq_analyst.hp_{—}2, which includes up to 15 before and after visits for each website_visit_id, and the sequential of web visit is defined within 60 minutes.
2. Based on the complete before and after visit data file from the previous step, create before file and after file separately and reformat them as the base files for navigation summarization.
   Run SQL query step by step:
   R:\custom\2010\ACTIVE PROJECTS\Hall & Partners—L4456 Toyota Web Tracking\Specs\SQL\Create All before and after website_list.
      i. Note the dw_zq_analyst.hp_{—}2 file generated in the previous step only defines member list and target website list, but not time frame. In another word, this file includes the records of the target members who have visited the target websites in the entire time frame. So the first step is to produce a sub file from dw_zq_analyst.hp_{—}2 file that includes only the records in the desired time frame, and this sub file is our base file to generate separate before file and after file.
      ii. Create separate before file and after file that include complete before/after web visits for each member/web visit. In Toyota Tribe case, the files are dw_zq_analyst.hp_before_all and dw_zq_analyst.hp_after_all, where all the target, before, and after website ids have been matched with their auto types and auto brands whenever applicable. These two files are our base files to summarize the navigation path by category.

c. Step 2—Data Analysis:
Summarize the before/after web visits by category.
1. Continue to run the lower part of SQL query: R:\custom\2010\ACTIVE PROJECTS\Hall & Partners—L4456 Toyota Web Tracking\Specs\SQL\Create All before and after website_list.
2. Need to change the scopes of target websites, before/after websites, and the members to reflect the desired conditions.
3. In Toyota Tribe case, use Auto Categories to summarize the auto-related before/after websites, and Non-auto Categories (from Google AdPlanner) to summarize the non-auto before/after websites.

d. Step 3—Output:
The SQL output of navigation is saved at R:\custom\2010\ACTIVE PROJECTS\Hall & Partners—L4456 Toyota Web Tracking\Specs\Before_After Output. For each run, compute the % of each category based on the total sum of # of visits of both auto and non-auto categories.

e. Data Sources in the ZQ Data:
Tables dw_zq.dw_website_visits_clean,
st_zq_operational.st_website_category_mappings, and
st_zq_operational.st_site_categories, and the analyst-defined tables of target member-ids and target website-ids (in Toyota Tribe case,
dw_zq_analyst.hp_members_final and dw_zq_analyst.hp_auto_websites) in the Greenplum database. In Toyota Tribe case, we also need the analyst-defined table of dw_zq_analyst.client_auto_cats_{—}2 in the Greenplum database to summarize auto categories.

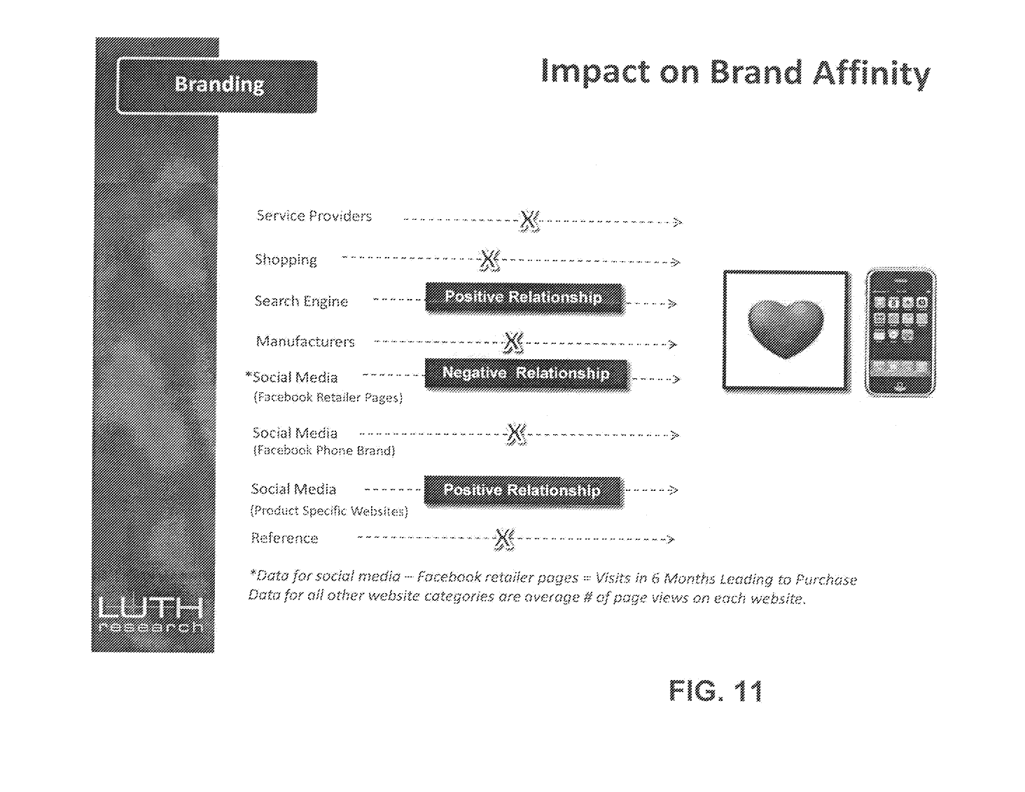

FIG. 11 depicts a graphical analysis of the impact on brand affinity with respect to service providers, search engines and social media sites. In greater detail this search term analysis category report process can be described as follows:

Domains of Influence Analysis

a. Brief Description:
Advanced statistical procedures such as logistic regression and structural equation modeling are used to determine what website destinations are most influential in visitors' purchase propensity and brand perceptions in a specific product category. The website domains that carry the most weight are identified and their impact is assessed.
The results enhance marketers' competence in being laser focused on working with the publishers and ad networks that matter the most.

Impacts of Web Visit Counts, Time Spent, and # of Page Viewed on Purchasing Timeframe and Brand Affinity

b. Step 1—Data Preparation:
ii. Use the following SQL queries to pull data from ZQ database.
   1. Counts of web visits:
      a. R:\custom\2010\ACTIVE PROJECTS\LUTH—L9993 ZQ Consumer Electronics Survey\Specs\SQL\Mobile_WebCate_JR_{—}8_{—}10
      b. R:\custom\2010\ACTIVE PROJECTS\LUTH—L9993 ZQ Consumer Electronics Survey\Specs\SQL\Camera_WebCate_JR_{—}8_{—}10
   2. Time Spent:
      a. R:\custom\2010\ACTIVE PROJECTS\LUTH—L9993 ZQ Consumer Electronics Survey\Specs\SQL\Mobile_Web_timespent_{—}8_{—}10
      b. R:\custom\2010\ACTIVE PROJECTS\LUTH—L9993 ZQ Consumer Electronics Survey\Specs\SQL\Camera_Web_timespent_{—}8_{—}10
   3. # of page viewed:
      a. R:\custom\2010\ACTIVE PROJECTS\LUTH—L9993 ZQ Consumer Electronics Survey\Specs\SQL\Mobile_Pageviewed_{—}8_{—}10
      b. R:\custom\2010\ACTIVE PROJECTS\LUTH—L9993 ZQ Consumer Electronics Survey\Specs\SQL\Camera_Pageviewed_{—}8_{—}10
   4. Counts of web visits in each day of week (Note this query is to pull data for each day of a week, and you need to run it multiple times to get data for all seven days and update day of week definition in each run):
      a. R:\custom\2010\ACTIVE PROJECTS\LUTH—L9993 ZQ Consumer Electronics Survey\Specs\SQL\Mobile_WebVisitCounts_Week day_{—}8_{—}10
      b. R:\custom\2010\ACTIVE PROJECTS\LUTH—L9993 ZQ Consumer Electronics Survey\Specs\SQL\Camera_WebVisitCounts_Week day_{—}8_{—}10
iii. Combine ZQ variables with survey data
   1. R:\custom\2010\ACTIVE PROJECTS\LUTH—L9993 ZQ Consumer Electronics Survey\Data\Combined_Data_CellPhone_{—}8_{—}10.sav;
   2. R:\custom\2010\ACTIVE PROJECTS\LUTH—L9993 ZQ Consumer Electronics Survey\Data\Combined_Data_DigitCamera_{—}8_{—}10.sav.
   3. The above two files are the combined SPSS data files of survey and ZQ variables.

c. Step 2—Data Analysis:
iv. Run logistic regression and GLM against purchase timeframe and brand affinity.
   1. R:\custom\2010\ACTIVE PROJECTS\LUTH—L9993 ZQ Consumer Electronics Survey\Tabs\Regression_{—}8_{—}10.spv

d. Step 3—Output:
v. R:\custom\2010\ACTIVE PROJECTS\LUTH—L9993 ZQ Consumer Electronics Survey\Tabs\Regression Results_{—}8_{—}10.xlsx.
Data Sources in the ZQ data: Tables dw_zq.dw_website_visits_clean and the analyst-defined tables of target member-ids and target website-ids (in Toyota Tribe case, dw_zq_analyst.hp_members_final) in the Greenplum database. In Toyota Tribe case, we also need the analyst-defined table of dw_zq_analyst.client_auto_cats_{—}2 in the Greenplum database to summarize auto categories.

Impacts of social media (Facebook) on purchasing timeframe and brand affinity. This analysis is to identify the impact of social media sites on purchase timeframe and brand affinity.

e. Step 1—Data Preparation:
vi. Pull data from ZQ database on Facebook website. The page_viewed list is cleaned and relevant page view IDs are tagged and coded by project manager. Counts of web visits:
   1. Camera related:
      a. R:\custom\2010\ACTIVE PROJECTS\LUTH—L9993 ZQ Consumer Electronics Survey\Specs\SQL\Facebook_Camera_{—}8_{—}12;
   2. Mobile related:
      a. R:\custom\2010\ACTIVE PROJECTS\LUTH—L9993 ZQ Consumer Electronics Survey\Specs\SQL\Facebook_Mobile_{—}8_{—}12;
   3. Retailer related:
      a. R:\custom\2010\ACTIVE PROJECTS\LUTH—L9993 ZQ Consumer Electronics Survey\Specs\SQL\Facebook_Retailer_{—}8_{—}12
vii. Combine ZQ data with survey data and the complete SPSS data files are saved as:
   1. R:\custom\2010\ACTIVE PROJECTS\LUTH—L9993 ZQ Consumer Electronics Survey\Data\Combined_Data_CellPhone_{—}8_{—}10.sav;
   2. R:\custom\2010\ACTIVE PROJECTS\LUTH—L9993 ZQ Consumer Electronics Survey\Data\Combined_Data_DigitCamera_{—}8_{—}10.sav.
   3. The above two files are the combined SPSS data files of survey and ZQ variables.

f. Step 2—Data Analysis:
viii. Run logistic regression and GLM against purchase timeframe and brand affinity.
   1. R:\custom\2010\ACTIVE PROJECTS\LUTH—L9993 ZQ Consumer Electronics Survey\Tabs\Regression_{—}8_{—}10.spv

g. Step 3—Output:
ix. R:\custom\2010\ACTIVE PROJECTS\LUTH—L9993 ZQ Consumer Electronics Survey\Tabs\Facebook_{—}8_{—}12.xlsx.
Data Sources in the ZQ data: Tables dw_zq.dw_website_visits_clean and the analyst-defined tables of target member-ids and target website-ids (in Toyota Tribe case, dw_zq_analyst.hp_members_final) in the Greenplum database. In Toyota Tribe case, we also need the analyst-defined table of dw_zq_analyst.client_auto_cats_{—}2 in the Greenplum database to summarize auto categories.

Impacts of Monthly Web Visit Counts, Time Spent, and # of Page Viewed on the Likelihood to Purchase within the Next Three Months

h. Step 1—Data Preparation:
x. Pull monthly ZQ variables on counts of web visits, time spent, and # of page viewed.
   1. Counts of web visits and time spent:
      a. R:\custom\2010\ACTIVE PROJECTS\LUTH—L9993 ZQ Consumer Electronics Survey\Specs\SQL\Mobile_WebCounts_Monthly_{—}8_{—}10;
      b. R:\custom\2010\ACTIVE PROJECTS\LUTH—L9993 ZQ Consumer Electronics Survey\Specs\SQL\Mobile_Time_Monthly_{—}8_{—}10;
      c. R:\custom\2010\ACTIVE PROJECTS\LUTH—L9993 ZQ Consumer Electronics Survey\Specs\SQL\Camera_Webcounts_Time_Monthly_{—}8_{—}10.
   2. # of Page Viewed:
      a. The query for # of page viewed is more complex, so we split the whole data into two files for safety and efficiency. Be sure to combine them together in the final SPSS file.
         i. R:\custom\2010\ACTIVE PROJECTS\LUTH—L9993 ZQ Consumer Electronics Survey\Specs\SQL\Mobile_Pageviewed_Monthly_{—}8_{—}10_{—}1 (January-March); Mobile_Pageviewed_Monthly_{—}8_{—}10_{—}2 (April-June).
         ii. R:\custom\2010\ACTIVE PROJECTS\LUTH—L9993 ZQ Consumer Electronics Survey\Specs\SQL\Camera_Pageviewed_Monthly_{—}8_{—}10_{—}1 (January-March);
         iii. Camera_Pageviewed_Monthly_{—}8_{—}10_{—}2 (April-June).
xi. Combine ZQ data with survey data to get complete SPSS data files:
   1. R:\custom\2010\ACTIVE PROJECTS\LUTH—L9993 ZQ Consumer Electronics Survey\Data\ Combined_Data_CellPhone_all_{—}8_{—}10.sav;
   2. R:\custom\2010\ACTIVE PROJECTS\LUTH—L9993 ZQ Consumer Electronics Survey\Data\ Combined_Data_DigitCamera_all_{—}8_{—}10.sav
   3. Note these two files include everybody in the survey, even those who do not have the specific product, because we try to find out who will purchase within the next three months no matter whether he currently has this product or not.

i. Step 2—Data Analysis:
xii. Run logistic regression against QS7 (likelihood to purchase the product within next three months).
   1. R:\custom\2010\ACTIVE PROJECTS\LUTH—L9993 ZQ Consumer Electronics Survey\Tabs\QS7_Purchase within next 3 months.spv

j. Step 3—Output:
xiii. R:\custom\2010\ACTIVE PROJECTS\LUTH—L9993 ZQ Consumer Electronics Survey\Tabs\QS7_Mobile.xlsx;
xiv. R:\custom\2010\ACTIVE PROJECTS\LUTH—L9993 ZQ
Consumer Electronics Survey\Tabs\QS7_Camera.xlsx.
Data Sources in the ZQ data: Tables dw_zq.dw_website_visits_clean and the analyst-defined tables of target member-ids and target website-ids (in Toyota Tribe case, dw_zq_analyst.hp_members_final) in the Greenplum database. In Toyota Tribe case, we also need the analyst-defined table of dw_zq_analyst.client_auto_cats_{—}2 in the Greenplum database to summarize auto categories.

### EXAMPLE 1

### Tribe Definition

Establishment of Objectives

Objectives will be defined by closely collaborating with the client to determine research goals and selection of appropriate methodologies. The target audience is defined to include qualification criteria and participation quotas. The participation quotas will ensure that the target audience is in-line with the desired objectives and will be monitored throughout the Tribe project.

Selection of Tribe Type

There are five examples of ZQ Tribe types, each with their own methodology, metrics, and analysis. These include Impact Monitoring, Digital Life, Cross Media, Multi-Sense and Behavioral Pattern.

Impact Monitoring Tribe

A Monitoring Tribe establishes behavior before and after subjecting the Tribe to predefined stimuli. The preexisting behavior is documented by conducting profiling during Tribe Recruitment and/or Surveying prior to monitoring during the observational periods. Observational periods are defined, typically 2 to 4 weeks prior to and after the exposure to selected stimuli. The stimuli may be one or more surveys, advertisement exposures or other communication provided at mid-term of the fielding process. A second observational period is conducted after exposure to the stimuli and a post-monitoring survey is conducted at the end of the fielding. Potential qualitative in-depth interviews can be added to aid the overall research objectives.

Digital Life Tribe

A Digital Life Tribe is conducted by uninfluenced observation of the Tribe's web behavior encompassing all captured website visits during the Tribe time frame. The defined observation period is typically 4 to 8 weeks.

Cross Media Tribe

The Cross Media Tribe integrates multiple media platform tracking to derive understanding of how people spend time with digital (e.g., computer and mobile) and non-digital (e.g., print) media in order to determine individual as well as combined effect of the media. This is accomplished by profiling during the recruitment process to determine non-digital and digital media usage behaviors and inclinations, establishing a self-reporting process such as a diary or log of non-digital behaviors during the observational period and a series of one or more surveys during or following the observational period. During the observational period, multiple tracking technological mechanisms are employed to record media usage related to mobile, computer, TV or other pertinent media types. The non-digital media data (e.g., TV set-up box viewing data) can be appended and transferred from a third party source. Potential qualitative in-depth interviews of select respondents may be added to enrich the understanding of the overall objectives.

Multi-Sense Tribe

The Multi-Sense Tribe captures behavioral, emotional and neurological responses from the Tribe to inform on any given research objective. This is accomplished by collecting the digital behavioral data Tribe members using the SavvyConnect application as well as utilizing sensory tracking technology and survey data to acquire emotional and neurological data. Potential qualitative in-depth interviews of select respondents may be added to enrich the understanding of the overall objectives.

Behavioral Pattern Tribe

The Behavioral Pattern Tribe defines how a digital population executes a predetermined task or behavior. The Tribe is given a task or behavior to execute over the course of the monitoring period and this behavior is tracked with the SavvyConnect application. Potential surveys and qualitative in-depth interviews of select respondents may be added to enrich the understanding of the overall objectives.

Definition of Tribe Details

Once the Type of the Tribe is chosen, the additional details are decided upon including the total population, length of engagement, additional data sources required and the specific deliverables.

Recruitment

Recruitment of the ZQ Tribe may take many forms as determined by the specific needs and goals of the Tribe. There are various sample sources and contact methods that may be instituted.

Sourcing the Sample

Participants may be sourced directly from the ZQ Research Panel which includes members already participating in Tribe Research and ZQ Tribes. This method provides for easier recruitment and faster fielding. Participants may also be recruited from Online Research Panels including but not limited to SurveySavvy. Marketing lists may be employed for recruitment, as well as client provided contact lists. Digital advertisement and recruitment may be used to funnel internet traffic into the recruitment process. Methods for contacting the recruits may include digital marketing and advertisement, email, social network messaging, text messaging, phone calls and direct mailing.

Screening and Qualification

Upon contacting the prospective Tribe Recruits, they are processed through a screening process to determine qualifications. The technology screening ensures they meet the technical requirements for SavvyConnect. Demographic screening and quota establishment ensure that the Tribe meets the correct target audience and desired respondent composition for the project. Additional profiling may be conducted at this point to collect specific data points needed for the Tribe. Additional data sources, including off-line transactions and segmentation data, may be appended to provide for additional qualification and screening criteria.

If the participant meets all qualification criteria and has an available quota group they are given the opportunity to join the Tribe. Upon agreement to the SavvyConnect Terms and Conditions the recruits are directed to the SavvyConnect Download link. If the recruit does not meet the qualification criteria or does not have an available quota group they are prompted to join the ZQ Research Panel by downloading SavvyConnect and may be offered participation in a future Tribe. If the recruit does not meet the technical requirements or chooses not to agree to the terms and conditions they are removed from consideration for the Tribe and the ZQ Research Panel.

After SavvyConnect is downloaded and activated the recruits will not be considered confirmed until browsing data is communicated to the ZQ servers by SavvyConnect. A pre-determined data volume threshold is used to gauge if a respondent is sending acceptable amount of data that is worth analyzing for the tribe. Once this threshold is met, the SavvyConnect Support Team will inform the respondent of his or her qualified and successful status for tribe participation. Unconfirmed respondents will be contacted to be made aware of the unsuccessful participation status. When agreed upon, a 10% or more recruits may be over-recruited into the tribe to offset possible drop-outs during the tribe engagement time frame.

Tribe Activation

Once the appropriate number of participants is recruited to the Tribe and actively sending data at the acceptable data volume threshold the Tribe is considered Active and the fielding phase begins.

Tribe Fielding

Observational Periods

Observational periods are established in the Tribe Definition phase and typically have minimum participation guidelines that require participants to send SavvyConnect browsing data for at least 4 days each 7 day period. The criteria for acceptable threshold for browsing data may be revised and adjusted based on tribe objectives and client requirement. If the Tribe participants fall below the minimum participation threshold they are contacted by the SavvyConnect Support Team to increase participation. If the participants continue to be below the minimum participation threshold they may be removed from the Tribe.

Impact Monitoring Tribe

At the beginning of fielding a pre-monitoring survey is conducted during which all members participate by taking an online research survey. This survey is communicated via multiple methods including email, phone, SMS or within the SavvyConnect application. Following this pre-monitoring survey an observational period follows which typically lasts between two and four weeks. Upon completion of the monitoring period, one or more stimuli are introduced. These stimuli may be in the form of messaging or communication, surveys, advertisement exposure, or other action which may influence behavior. Following the exposure to stimuli, an additional observational period is conducted which typically lasts two to four weeks. After this observational period, a post-monitoring survey is conducted in which additional data is collected from the Tribe participants. Potential qualitative in-depth interviews of select respondents may be conducted to further aid the overall research objectives.

The data set is completed by integrating the profiling, demographic, survey, interviews and ZQ browsing data provided by SavvyConnect. Additionally, this data may be augmented by third party or client provided data sets which may include off-line transactional or segmentation data or other data determined by the Tribe details.

Digital Life Tribe Fielding

Digital Life Tribe fielding consists of a four to eight week Observational period of uninterrupted ZQ browsing data provided by the SavvyConnect application. Upon completion of the observational period, the ZQ browsing data is integrated with the profiling and demographic data as well as additional third party or client provided data determined by the Tribe details. Potential surveys and qualitative in-depth interviews of select respondents may be conducted to further aid the overall research objectives.

Cross Media Tribe Fielding

The Cross Media Tribe fielding consists of an observational period of four to eight weeks during which the participants will conduct self-reported observations at a predetermined rate. These self-reported observations may be in the form of a diary or blog which provides insights into what they are doing outside of their digital world. Upon completion of the observational period, the ZQ browsing data is combined with the self-reported data from the diary/blog. When applicable, any additional media usage data recorded by other tracking technological mechanisms (e.g., a mobile tracking technology or a TV set-up box technology) are also added and appended to individual participants' data streams. This is followed up with one or more post-observational surveys to gain added insights into the Tribe participant's activity. Potential qualitative in-depth interviews of select respondents may be conducted to further aid the overall research objectives.

The integrated data set contains the digital data collected by SavvyConnect and any other media tracking technological mechanisms, the non-digital behavioral data provided by the self-reporting process, additional third party or client data determined by the Tribe details the survey data from the post-observational surveys, qualitative in-depth interviews to provide a comparison and contrast of these behaviors to determine causality and other relationships.

Multi-Sense Tribe Fielding

The Multi-Sense Tribe fielding consists of an observational period of four to eight weeks. During this observational period both SavvyConnect browsing data and sensory data provided by either sensor tracking technologies are collected. These data sets are integrated on time stamp indices to allow for building correlations between emotional and neurological data and the digital behavior collected by SavvyConnect. Follow up surveys may be conducted after monitoring to gain additional insights into behavior and emotional state. Additional data sources such as third party and client provided data may be integrated as well. Potential qualitative in-depth interviews of select respondents may be conducted to further aid the overall research objectives. These combined data sets are analyzed to provide a comprehensive view of the activities and influences that occur during the observational period.

Behavioral Pattern Tribe Fielding

The Behavioral Pattern Tribe fielding begins with the communication of a tasking or behavior to accomplish. Once communicated, the Tribe participants Internet browsing activities are monitored with the SavvyConnect application for the duration of a two to four week monitoring period. The data are marked with clear time stamp indices to allow for time sequence analysis and correlation analysis among behaviors. After completion of the monitoring period, the SavvyConnect browsing data is integrated with profiling, demographic, and other data sets including third party and client provided data.

Validation of Tribe

Tribe member participation is monitored to ensure minimum participation standards and Tribe specific requirements are being met. If a member does not meet participation standards or fails to complete Tribe specific project requirements a member of the SavvyConnect Support Team will contact the member directly. Key participation attributes being monitored are;
If they fail to completely download and install the SavvyConnect application
If they install the SavvyConnect application but do not send data
If they uninstall the SavvyConnect application and stop sending data the next day
If they stop sending data for 7 consecutive days
If they have not responded to a Tribe related survey by the specified deadline
If they have not visited a site or met previously agreed to Tribe project requirement by the specified deadline
If they have not participated in a qualitative in-depth interview or discussion as required by the project

Tribe Data Set Complete

Analysis and Reporting

Data Analysis

Weekly Pattern/Day Part Pattern Analysis

The data for the identified relevant metrics (e.g., search terms, visits, etc.) are analyzed tracing how the activities fluctuate across weekdays and weekends or across day parts of a typical day (e.g., early morning, fringe). The peaks and lows of the activities indicate opportunities for companies to increase or decrease marketing efforts based on time patterns.

Search Term Analysis

Search is a common consumer activity online. Search term analysis has two dimensions. First, search terms are coded into categories or themes that are relevant to a topic of interest (e.g., searches for digital camera). Second, search terms are coded in terms of whether each search term contains a brand name, which allows researchers to analyze the significance of branded searches as opposed to unbranded searches. Insights from this analysis inform decisions on search engine optimization strategies, and quantify the impact of search within a specific product category.

Site Correlation Analysis

Visitors to target websites of interest identified by the client are examined to determine what other websites they visit are of high probability and high relevance to the research topics. A group of highly visited websites by these visitors are compiled and categorized based on their degree of correlation to the target websites of interest. Clients can leverage the insights to drive cross-site traffic and identify optimal destinations to attract target audience.

Best Path Analysis

For every website of interest or domain of influence, there is a digital path leading to it and another one it leads to. This analysis answers questions such as “Does most of the traffic to the website come from search engine?”, “How many other websites on average do consumers visit prior to coming to my website?”, “Where do my customers go after they leave my website?” The analysis not only provides competitive intelligence on consumer shopping and content consumption behaviors, but also exposes the underlying digital path which can be shaped by relevant marketing tactics.

Domains of Influence Analysis

Advanced statistical procedures such as logistic regression and structural equation modeling are used to determine what website destinations are most influential in visitors' brand perceptions in a specific category. The website domains that carry the most weight are identified and their impact is assessed. This includes, but not limited to; Impacts of web visit counts, time spent, and # of page viewed on brand affinity, Impact of Social media (such as Facebook, etc.) on brand affinity and Impacts of web visit counts, time spent, and # of page viewed on brand affinity.

The on-line behavior research method using client/customer survey groups system and method 10 shown in the drawings and described in detail herein, enables the following capabilities, including but not limited to:
the capability to custom recruit to yield a higher degree of precision;
the capability to recruit from different sources of sample including Applicant's own panel, client-provided sample, or any given list of respondents, and download the tracking application onto their computers or other devices for permission-based tracking; whereby this capability broadens the clients' access to relevant respondents and yields both time and cost efficiency
the capability to integrate behavioral data and survey data;
the capability to integrate behavioral data and qualitative research data;
the capability to integrate behavioral data and multi-sensory data including physiological, eye-movement and other data captured through follow up research;
the capability to integrate behavioral data and 3rd-party data including transaction data;
the capability to integrate multiple tracking mechanisms or technologies (such as computer-based online tracking and mobile tracking) with a single group of respondents, which enhances accuracy in measuring cross-platform behaviors;
the capability to do the above data integration for the same individuals as opposed to any other matching alternatives such as data fusion or matching based on zip code or age cohort, which enables generation of insights based on accurate correlation analysis;
the capability to capture and monitor online behaviors during a very specifically defined time frame, which provides the flexibility in research design to enhance the relevance of the resulting data and analysis; for example, if the client advertising campaign starts and stops at specific times, the ZQ Tribe system can create a tribe that spans across those critical milestones among the relevant audience;
the capability to administer stimuli and/or experimental designs as part of the tribe process to determine any ensuing behavioral and/or attitudinal changes, captured by the online tracking and follow up surveys, qualitative research and multi-sensory research;
the capability to develop industry specific, product category-specific statistical models that determine the corresponding level of influence from both online behavioral factors and off-line factors such as those data points captured through follow up survey, qualitative research, and multi-sensory research; and
the capability to develop, compile and present online behavioral patterns and trends pertinent to addressing business objectives in marketing such as how consumers shop in a product category, how consumers are affected by advertising, and how consumers consume digital media content.

The on-line behavior research method using client/customer survey groups system and method 10 shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed for providing a on-line behavior research method using client/customer survey groups system and method 10 in accordance with the spirit of the invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. A computer implemented web-based system for on-line behavior research using client/customer survey/research respondent groups known as tribes comprising:
a) a definition module for the purpose of defining a client/customer survey/research respondent groups known as a tribe;
b) a recruitment module for the purpose of recruiting a defined client/customer survey/research respondent groups known as a tribe;
c) a fielding module for the purpose of fielding a defined and recruited client/customer survey/research respondent groups known as a tribe to generate a tribe data set; and
d) an analysis and reporting module for the purpose of analyzing and reporting on the tribe data set to generate optimal tribe recommendations;
whereby said system enables a user to derive an optimal understanding of on-line behavior and provides the capability to custom recruit research respondents for online behavior monitoring based on client-provided criteria, affording companies a much higher degree of precision in researching the target audience;
and further wherein the system provides companies with an integrated approach combining behavioral data and survey data to derive a broader and more in-depth understanding of human decisions.

2. The computer implemented web-based system for on-line behavior research using client/customer survey/research respondent groups known as tribes according to claim 1, wherein said definition module includes sub-modules for establishing objectives, selecting tribe types and defining tribe parameters.

3. The computer implemented web-based system for on-line behavior research using client/customer survey/research respondent groups known as tribes according to claim 1, wherein said recruitment module includes sub-modules for sampling sources, screening, and downloading SavvyConnect communication applications, leading to a ZQ Research Panel and ZQ Tribe.

4. The computer implemented web-based system for on-line behavior research using client/customer survey/research respondent groups known as tribes according to claim 1, wherein said fielding module includes sub-modules for performing surveys and stimuli data collection, monitoring on-line behavior and data integration and allows for a screening questionnaire leading to fielding a defined tribe.

5. The computer implemented web-based system for on-line behavior research using client/customer survey/research respondent groups known as tribes according to claim 2, wherein said tribe definition sub-modules after establishing objectives, define a target audience using pre-determined qualification criteria and participation quotas, selects a tribe type and further includes sub-modules that monitor on-line behavior, digital life activity, cross media activity, multi-sense activity, and behavioral patterns, wherein said definition module calculates tribe details by employing total tribe population data, determining the length of engagement, defining data sources and defining deliverables, resulting in the of definition of a tribe.

6. The computer implemented web-based system for on-line behavior research using client/customer survey/research respondent groups known as tribes according to claim 1, wherein said tribe recruitment module further comprises sub-modules for sample sourcing, screening and qualification, agreement and installation, and tribe activation, to determine qualified quota groups for qualifying a tribe.

7. The computer implemented web-based system for on-line behavior research using client/customer survey/research respondent groups known as tribes according to claim 1, wherein said fielding module calculates a tribe data set utilizing data collection pathways of:
(1) on-line behavior monitoring involving a pre-monitoring survey, a first observation cycle, stimuli, a second observation cycle, a post-monitoring survey, and monitoring tribe data integration;
(2) digital life analysis, an observation cycle, and digital life tribe data integration;
(3) cross-media analysis, an observation cycle, one or more follow-up research surveys, and cross-media tribe data integration.
(4) multi-sense analysis, an observation cycle, one or more follow-up research surveys, and multi-sense tribe data integration; and
(5) behavior pattern analysis, followed by task assignment, an observation cycle, one or more follow-up research surveys, and behavioral pattern tribe data integration.

8. The computer implemented web-based system for on-line behavior research using client/customer survey/research respondent groups known as tribes according to claim 7, wherein all of said pathways further include qualitative in-depth interviews and integration of data collected in qualitative in-depth interviews.

9. The computer implemented web-based system for on-line behavior research using client/customer survey/research respondent groups known as tribes according to claim 1, wherein said tribe analysis and reporting module generates tribe recommendations by performing analytical procedures of generated tribe data sets including weekly pattern or day part pattern analysis, search term analysis, site correlation analysis, best path analysis and domains of influence analysis;
whereby these analysis procedures can be selected by the client to be implemented individually or as a group to best address research objectives outlined at the onset of the tribe; and
wherein said tribe analysis and reporting module generates tribe reports, including weekly pattern analysis reports, search term analysis reports, site correlation analysis reports, best path analysis reports and domains of influence analysis reports;
whereby said reports lead to tribe recommendations which are thereby generated to guide the client's decisions and actions to achieve more effective marketing practices and enhance business outcome.

10. The computer implemented web-based system for on-line behavior research using client/customer survey/research respondent groups known as tribes according to claim 1, wherein said fielding module performs validation of the tribe members following recruitment based upon tribe member participation which is monitored to ensure minimum participation standards and pre-determined tribe specific requirements are being met.

11. A computer implemented method for making a web-based system for on-line behavior research using client/customer survey/research respondent groups known as tribes comprising the steps of:
a) providing a definition module for the purpose of defining a client/customer survey/research respondent groups known as a tribe;
b) providing a recruitment module for the purpose of recruiting a defined client/customer survey/research respondent groups known as a tribe;
c) providing a fielding module for the purpose of fielding a defined and recruited client/customer survey/research respondent groups known as a tribe to generate a tribe data set; and
d) providing an analysis and reporting module for the purpose of analyzing and reporting on the tribe data set to generate optimal tribe recommendations;
whereby said method enables a user to derive an optimal understanding of on-line behavior and provides the capability to custom recruit research respondents for online behavior monitoring based on client-provided criteria, affording companies a much higher degree of precision in researching the target audience;
and further wherein the method provides companies with an integrated approach combining behavioral data and survey data to derive a broader and more in-depth understanding of human decisions.

12. The computer implemented web-based method for on-line behavior research using client/customer survey/research respondent groups known as tribes according to claim 11, wherein said definition module includes sub-modules for establishing objectives, selecting tribe types and defining tribe parameters.

13. The computer implemented web-based method for on-line behavior research using client/customer survey/research respondent groups known as tribes according to claim 11, wherein said recruitment module includes sub-modules for sampling sources, screening, and downloading SavvyConnect communication applications, leading to a ZQ Research Panel and ZQ Tribe.

14. The computer implemented web-based method for on-line behavior research using client/customer survey/research respondent groups known as tribes according to claim 11, wherein said fielding module includes sub-modules for performing surveys and stimuli data collection, monitoring on-line behavior and data integration and allows for a screening questionnaire leading to fielding a defined tribe.

15. The computer implemented web-based method for on-line behavior research using client/customer survey/research respondent groups known as tribes according to claim 12, wherein said tribe definition sub-modules after establishing objectives, define a target audience using pre-determined qualification criteria and participation quotas, selects a tribe type and further includes sub-modules that monitor on-line behavior, digital life activity, cross media activity, multi-sense activity, and behavioral patterns, wherein said definition module calculates tribe details by employing total tribe population data, determining the length of engagement, defining data sources and defining deliverables, resulting in the of definition of a tribe.

16. The computer implemented web-based method for on-line behavior research using client/customer survey/research respondent groups known as tribes according to claim 11, wherein said tribe recruitment module further comprises sub-modules for sample sourcing, screening and qualification, agreement and installation, and tribe activation, to determine qualified quota groups for qualifying a tribe.

17. The computer implemented web-based method for on-line behavior research using client/customer survey/research respondent groups known as tribes according to claim 11, wherein said fielding module calculates a tribe data set utilizing data collection pathways of:
(1) on-line behavior monitoring involving a pre-monitoring survey, a first observation cycle, stimuli, a second observation cycle, a post-monitoring survey, and monitoring tribe data integration;
(2) digital life analysis, an observation cycle, and digital life tribe data integration;
(3) cross-media analysis, an observation cycle, one or more follow-up research surveys, and cross-media tribe data integration.
(4) multi-sense analysis, an observation cycle, one or more follow-up research surveys, and multi-sense tribe data integration; and
(5) behavior pattern analysis, followed by task assignment, an observation cycle, one or more follow-up research surveys, and behavioral pattern tribe data integration.

18. The computer implemented web-based method for on-line behavior research using client/customer survey/research respondent groups known as tribes according to claim 17 wherein all of said pathways further include qualitative in-depth interviews and integration of data collected in qualitative in-depth interviews.

19. The computer implemented web-based method for on-line behavior research using client/customer survey/research respondent groups known as tribes according to claim 11, wherein said tribe analysis and reporting module generates tribe recommendations by performing analytical procedures of generated tribe data sets including weekly pattern or day part pattern analysis, search term analysis, site correlation analysis, best path analysis and domains of influence analysis;
whereby these analysis procedures can be selected by the client to be implemented individually or as a group to best address research objectives outlined at the onset of the tribe; and
wherein said tribe analysis and reporting module generates tribe reports, including weekly pattern analysis reports, search term analysis reports, site correlation analysis reports, best path analysis reports and domains of influence analysis reports;
whereby said reports lead to tribe recommendations which are thereby generated to guide the client's decisions and actions to achieve more effective marketing practices and enhance business outcome.

20. The computer implemented web-based method for on-line behavior research using client/customer survey/research respondent groups known as tribes according to claim 11, wherein said fielding module performs validation of the tribe members following recruitment based upon tribe member participation which is monitored to ensure minimum participation standards and pre-determined tribe specific requirements are being met.
